(19) United States
(12) Patent Application Publication
(10) Pub. No.: US 2012/0102942 A1
(43) Pub. Date: May 3, 2012

(54) BRAKE ACTUATION UNIT FOR ACTUATING A MOTOR VEHICLE BRAKE SYSTEM

(76) Inventors: Thomas Sellinger, Offenbach (DE); Peter Drott, Frankfurt (DE); Horst Krämer, Ginsheim-Gustavsburg (DE)

(21) Appl. No.: 13/318,968

(22) PCT Filed: Mar. 18, 2010
(86) PCT No.: PCT/EP10/53511

§ 371 Date: Jan. 18, 2012

(30) Foreign Application Priority Data
May 7, 2009 (DE) 10-2009-002-886.2
Mar. 15, 2010 (DE) 10-2010002850.9

(51) Int. Cl. B60T 13/74

(52) U.S. Cl. 60/545

(57) ABSTRACT

A brake actuation unit for actuating a motor vehicle brake system of the “Brake-by-wire” type, has a brake booster which can be actuated both by a brake pedal and by an electronic control unit as a function of a driver's request and has a piston rod. A mechanism is provided for decoupling a force-transmitting connection between the brake pedal and a brake booster in the “Brake-by-wire” operating mode. A distance ‘a’ is provided in order to decouple the brake pedal in the “Brake-by-wire” operating mode from reaction forces of the motor vehicle brake system. A securing element, which has a funnel-shaped receptacle oriented in the direction of the piston rod, is attached to the brake pedal to guide an end of the piston rod.

### CROSS REFERENCE TO RELATED APPLICATIONS

This application is the U.S. National Phase Application of PCT International Application No. PCT/EP2010/053511, filed Mar. 18, 2010, which claims priority to German Patent Application No. 10 2009 002 886.2, filed May 7, 2009, and German Patent Application No. 10 2010 002 850.9, filed Mar. 15, 2010, the contents of such applications being incorporated by reference herein.

### FIELD OF THE INVENTION

The invention relates to a brake actuation unit for actuating a motor vehicle brake system of the “Brake-by-wire” type, having a brake booster which can be actuated both by means of a brake pedal and by means of an electronic control unit as a function of a driver's request and has a piston rod, wherein means are provided for decoupling a force-transmitting connection between the brake pedal and the brake booster in the “Brake-by-wire” operating mode, a master brake cylinder arranged downstream of the brake booster, means for registering a driver's deceleration request, and a pedal travel simulator which interacts with the brake pedal and by means of which, in the “Brake-by-wire” operating mode, a restoring force acting on the brake pedal can be simulated independently of actuation of the brake booster, wherein, in order to decouple the brake pedal or a component assigned to the brake pedal from the piston rod as a component which is arranged downstream of the force flux and is assigned to the brake booster, a distance is provided in order to decouple the brake pedal in the “Brake-by-wire” operating mode from reaction forces of the motor vehicle brake system.

### BACKGROUND OF THE INVENTION

A brake system is known from DE 10 2007 044 423 A1, which is incorporated by reference, and is in widespread use in modern motor vehicles with a hybrid drive. The decoupling between the brake pedal and the brake booster in the “Brake-by-wire” operating mode is brought about here by a gap between a component assigned to the brake pedal and a component assigned to the brake booster. For this purpose, the known brake actuation unit has a piston rod whose piston rod head is embodied as a U-shaped bent part which engages around the brake pedal. The piston rod head has, for the purpose of guiding a bolt attached to the pedal, two limbs running parallel to one another on both sides, in which limbs longitudinal guiding openings are formed as openings which are produced by punching. There is an axial gap between the bolt and a fork headpiece. Said gap ensures during regeneration, i.e. in the case of braking by means of a generator, that a predefined distance is maintained from the brake booster (decoupling). On the other hand, in the event of failure of the electronics a positively locking contact is produced with the brake booster.

The complex design and the additional technical complexity involved in assembly of the piston rod are considered to be disadvantageous.

### SUMMARY OF THE INVENTION

A brake actuation unit for actuating a motor vehicle brake system of the “Brake-by-wire” type, has a brake booster which can be actuated both by means of a brake pedal and by means of an electronic control unit as a function of a driver's request and has a piston rod, wherein means are provided for decoupling a force-transmitting connection between the brake pedal and the brake booster in the “Brake-by-wire” operating mode, a master brake cylinder arranged downstream of the brake booster, means for registering a driver's deceleration request, and a pedal travel simulator which interacts with the brake pedal and by means of which, in the “Brake-by-wire” operating mode, a restoring force acting on the brake pedal can be simulated independently of actuation of the brake booster, wherein, in order to decouple a force-transmitting connection between the brake pedal or a component assigned to the brake pedal and the piston rod as a component which is arranged downstream of the force flux and is assigned to the brake booster, a distance (a) is provided in order to decouple the brake pedal in the “Brake-by-wire” operating mode from reaction forces of the motor vehicle brake system, wherein, in order to guide an end of the piston rod, a securing element, which has a funnel-shaped receptacle oriented in the direction of the piston rod, is attached to the brake pedal.

There is provision here that, in order to guide an end of the piston rod, a securing element, which has a funnel-shaped receptacle oriented in the direction of the piston rod, is attached to the brake pedal. The receptacle serves, on the one hand, to guide the end of the piston rod during the assembly of the pedal unit with the brake booster. On the other hand, after the connection to the brake pedal the piston rod is guided by the receptacle and/or by the securing element. The guiding of the piston rod by means of the receptacle and/or the securing element produces the axial gap or the distance which ensures decoupling of the force-transmitting connection between the brake pedal and the brake booster in the “Brake-by-wire” operating mode. A further advantage is to be seen in the fact that the brake pedal is not weakened in the region of the piston rod connection.

### BRIEF DESCRIPTION OF THE DRAWINGS

The invention is best understood from the following detailed description when read in connection with the accompanying drawings. Included in the drawings is the following figures:

FIG. 1 shows a known brake actuation unit of the generic type mentioned at the beginning;

FIG. 2 shows a pedal unit of a brake actuation unit according to aspects of the invention, and

FIG. 3 shows an enlarged view of the pedal unit according to FIG. 2 in a partially sectional view.

### DETAILED DESCRIPTION OF THE PREFERRED EMBODIMENTS

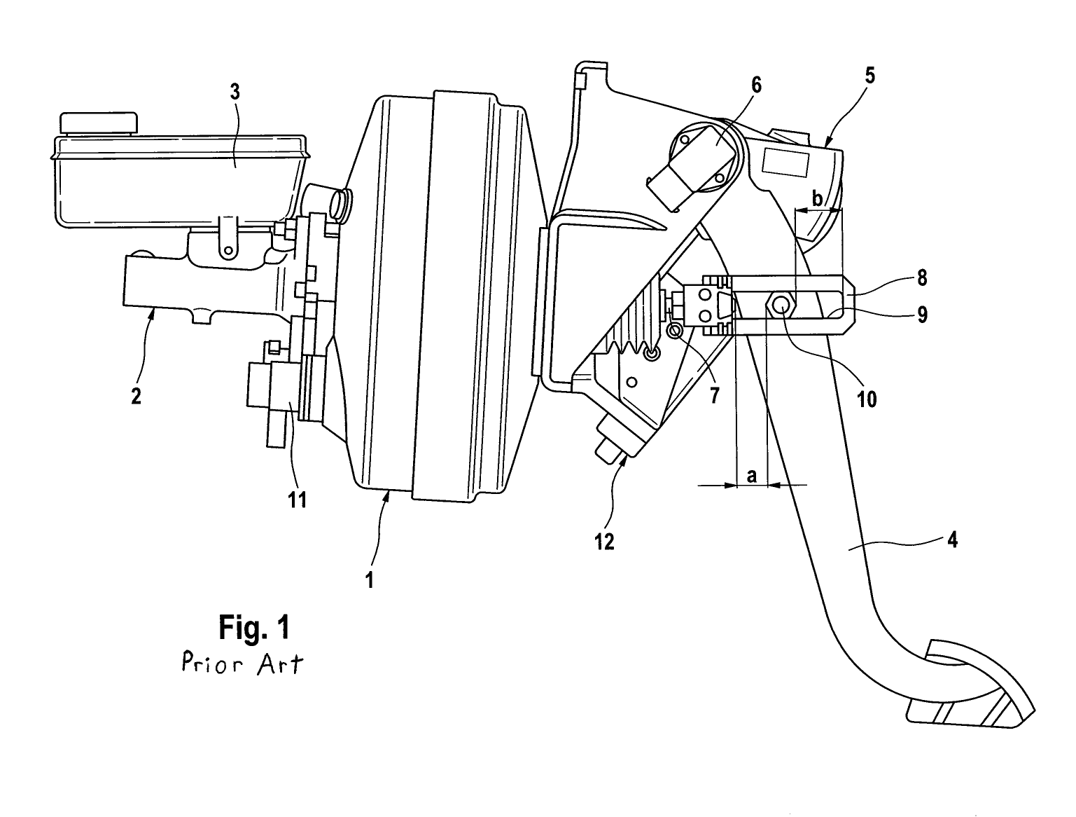

The known actuation unit which is illustrated in FIG. 1 is composed of a brake booster 1, preferably a partial vacuum brake booster, a master brake cylinder 2, preferably a tandem master cylinder, which is arranged downstream of the brake booster 1 and to whose pressure spaces (not illustrated) wheel brakes of the motor vehicle are connected with intermediate connection of a hydraulic open-loop and closed-loop control unit (not illustrated either), as well as a pressure medium reservoir vessel 3 which is assigned to the master brake cylinder 2. A brake pedal 4 serves for the actuation of the brake booster 1 by the driver, wherein a pedal travel simulator 5 (merely indicated) which interacts with the brake pedal 4, in particular in the “Brake-by-wire” operating mode, is provided, which gives the driver the usual brake pedal sensation. A driver's deceleration request or the actuation travel of the brake pedal 4 is registered by means of at least one sensor device 6 and the signals of which are fed to an electronic control unit (not shown). Inter alia, an electromagnet which is assigned to the brake booster 1 can be actuated by the output signals of the electronic control unit, which electromagnet permits a pneumatic control valve to be actuated independently of the driver's wishes and controls a supply of air to the brake booster 1.

An input element or a piston rod 7 which is coupled to the brake pedal 4 and which serves for the actuation of the above-mentioned control valve by the driver has a piston rod head 8 in which longitudinal guiding openings 9 are formed. The longitudinal guiding openings 9 receive a force-transmitting part 10 which is connected to the brake pedal 4 and which is embodied as a bolt. In this context, the specified parts 8, 10 are arranged in such a way that an axial gap or distance a is provided between the boundary of the longitudinal guiding openings 9 on the left-hand side in the drawing and the bolt 10, which gap or distance a ensures decoupling of the force-transmitting connection between the brake pedal 4 and the brake booster 1 in the “Brake-by-wire” operating mode. The axial gap or distance b, which is provided between the bolt 10 and the boundary of the longitudinal guiding openings 9 on the left-hand side in the drawing, ensures that the brake pedal 4 is not also moved along when the brake booster 1 is actuated independently of the driver's wishes. A travel sensor 11 serves to sense the travel of a movable wall which applies the booster force of the brake booster 1 or the travel of an output element of the brake booster 1 which transmits its output force to a first piston (not illustrated) of the master brake cylinder 2.

The pedal travel simulator 5 by means of which, as already mentioned, a restoring force which acts on the brake pedal 4 can be simulated independently of actuation of the brake booster 1 in the “Brake-by-wire” operating mode is embodied in such a way that, by means of an only schematically indicated activation and deactivation device 12, it can be activated in the event of decoupling of the force-transmitting connection between the brake pedal 4 and the brake booster 1 in the “Brake-by-wire” operating mode and can be deactivated outside the “Brake-by-wire” operating mode.

As is also apparent from FIG. 1, the piston rod head 8 is embodied as a U-shaped bent part which engages around the brake pedal 4. The piston rod head has, for the purpose of guiding a bolt attached to the pedal, two limbs running parallel to one another on both sides, in which limbs longitudinal guiding openings 9 are formed as openings which are produced by punching.

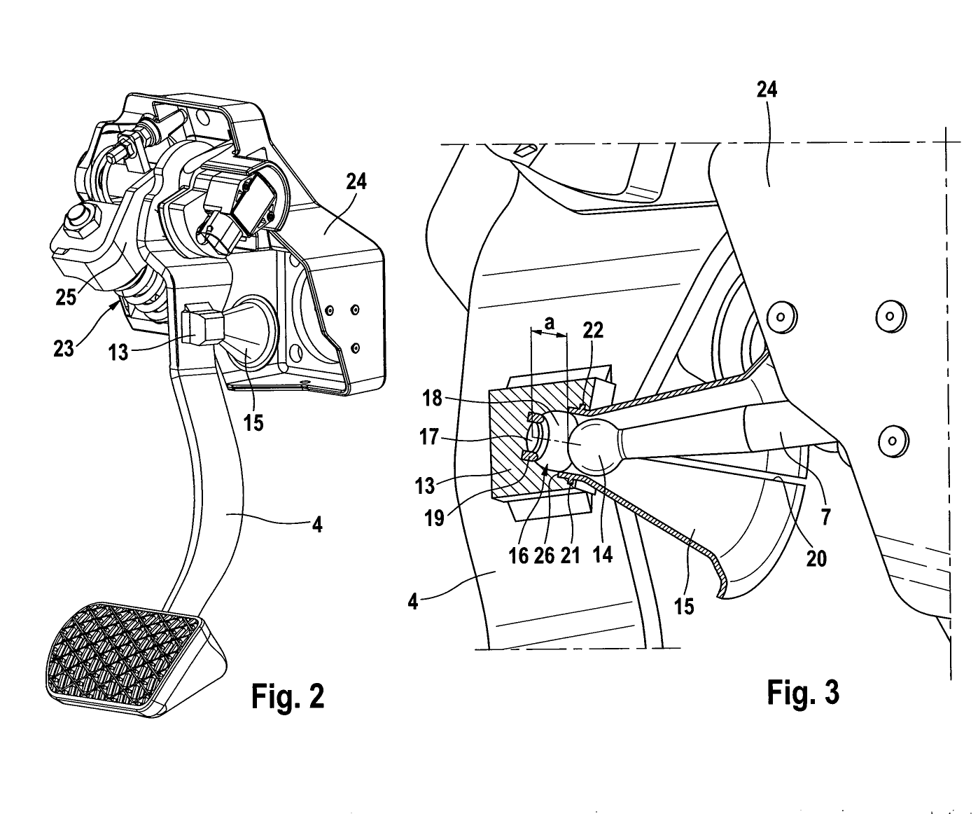

In order to make available a brake actuation unit which is improved in terms of the design and the technical complexity involved in assembly of the piston rod, the brake actuation unit according to aspects of the invention, whose pedal unit is illustrated in perspective in FIGS. 2 and 3, has, for the purpose of guiding one end 14 of the piston rod 7, a securing element 13 which is attached to the brake pedal 4 and has a funnel-shaped receptacle 15 which is oriented in the direction of the piston rod 7.

The receptacle 15 serves, on the one hand, to guide the end 14 of the piston rod 7, here in the form of a piston rod head, during the assembly of the pedal unit with the brake booster 1. On the other hand, after connection to the brake pedal 4, the piston rod 7 is guided by the receptacle 15 and/or by the securing element 13.

The guiding of the piston rod 7 by means of the receptacle 15 and/or the securing element 13 produces the axial gap or the distance a which ensures decoupling of the force-transmitting connection between the brake pedal 4 and the brake booster 1 in the “Brake-by-wire” operating mode.

A further advantage is that the brake pedal 4 is not weakened in the region of the piston rod connection, as in known brake actuation units according to FIG. 1.

As is clearly apparent, in particular, from FIG. 3 which shows an enlarged and partially sectional illustration of the pedal unit, the securing element 13 has a recess 16 on whose base 17 the end 14 of the piston rod 7 comes to bear outside the “Brake-by-wire” operating mode if the distance a is used up, in order to permit coupling between the brake pedal 4 and the brake booster 1.

In addition, FIG. 3 shows that the funnel-shaped receptacle 15 is attached to an inner wall 18 of the recess 16. For this purpose, the funnel-shaped receptacle 15 has an axial slot 20 and a radial projection 21, wherein the projection 21 is held under spring stress in an inner groove 22 in the inner wall 18 of the recess 16. As is apparent from FIG. 3, the inner wall 18 has, for the improved positioning of the receptacle 16, a step 26 on which the receptacle 16 bears after attachment.

Furthermore, in order to reduce noise in the case of contact of the end 14 with the base 17, a damping element 19, which is preferably embodied in the form of a damping ring, is furthermore provided on the base 17 of the recess 16.

The securing element 13 can be easily attached, for example, by welding, to the brake pedal 4.

The invention can be used in a brake actuation unit with a pedal travel simulator 5 and activation and deactivation device 12, as shown in FIG. 1 and described.

In contrast to FIG. 1, FIGS. 2 and 3 show a pedal travel simulator 23 whose force/travel characteristic is provided in a controllable fashion. The invention can also be used in such a configuration of the brake actuation unit.

Additional travel with a limited force level can be enabled by the control of the pedal characteristic if the “Brake-by-wire” system fails or relatively high braking power is necessary, with the result that a separate switching off of the pedal travel simulator 23 in the fallback level according to the described prior art no longer has to take place outside the “Brake-by-wire” operating mode. It is therefore particularly advantageous that there is no longer a need for a device for deactivating or activating the pedal travel simulator, as a result of which monitoring thereof can also be dispensed with.

The control of the force/travel characteristic, i.e. of the pedal travel, takes place, for example, in a force-dependent fashion, with the result that an extension of the pedal travel is made possible starting from a predetermined foot force applied on the brake pedal 4, and the reaction force which has to be applied at the same time does not exceed a defined limiting value.

The pedal travel simulator 23 is arranged here, for example according to FIG. 2, between a component of the pedal unit which is secured to the vehicle, referred to as the pedal block 24, and the brake pedal 4 or a component 25 in the form of a lever which can be rotated coaxially with respect to the brake pedal 4.

### LIST OF REFERENCE SYMBOLS

1 Brake booster
2 Master brake cylinder
3 Pressure medium reservoir vessel
4 Brake pedal
5 Pedal travel simulator
6 Sensor device

### 7 Piston rod

8 Piston rod head
9 Longitudinal guide
10 Force-transmitting part
11 Travel sensor
12 Activation and deactivation device
13 Securing element

### 14 End

### 15 Receptacle

### 16 Recess

### 17 Base

18 Inner wall
19 Damping element

### 20 Slot

### 21 Projection

22 Inner groove
23 Pedal travel simulator
24 Pedal block

### 25 Component

### 26 Step

a Distance

1.-6. (canceled)

7. A brake actuation unit for actuating a “Brake-by-wire” motor vehicle brake system comprising:
a brake booster which is configured to be actuated both by a brake pedal and by an electronic control unit as a function of a driver's request and has a piston rod,
means for decoupling a force-transmitting connection between the brake pedal and the brake booster in a “Brake-by-wire” operating mode,
a master brake cylinder arranged downstream of the brake booster,
means for registering a driver's deceleration request, and
a pedal travel simulator which interacts with the brake pedal and by which, in the “Brake-by-wire” operating mode, a restoring force acting on the brake pedal is simulated independently of actuation of the brake booster,
wherein, in order to decouple a force-transmitting connection between the brake pedal, or a component assigned to the brake pedal, and the piston rod, which is arranged downstream of a force flux and is assigned to the brake booster, a distance (a) is maintained in order to decouple the brake pedal in the “Brake-by-wire” operating mode from reaction forces of the motor vehicle brake system, and
wherein, in order to guide an end of the piston rod, a securing element, which has a funnel-shaped receptacle oriented in a direction of the piston rod, is attached to the brake pedal.

8. The brake actuation unit as claimed in claim 7, wherein the securing element has a recess,
wherein, outside the “Brake-by-wire” operating mode, the end of the piston rod comes to bear on a base of the recess, and the funnel-shaped receptacle is attached to an inner wall of the recess.

9. The brake actuation unit as claimed in claim 8, wherein a damping element is provided on the base of the recess in the securing element.

10. The brake actuation unit as claimed in claim 9, wherein the damping element is provided in the form of a damping ring.

11. The brake actuation unit as claimed in claim 7, wherein the securing element is attached to the brake pedal by welding.

12. The brake actuation unit as claimed in claim 7, wherein the funnel-shaped receptacle has an axial slot and a radial projection, wherein the projection is held under spring stress in an inner groove in an inner wall of the recess.
